(19) United States
(12) Patent Application Publication
(10) Pub. No.: US 2014/0319950 A1
(43) Pub. Date: Oct. 30, 2014

(54) Disc alternator or motor

(71) Applicant: Byron Earl Hough, Torrington, WY (US)

(72) Inventor: Byron Earl Hough, Torrington, WY (US)

(21) Appl. No.: 13/986,385

(22) Filed: Apr. 26, 2013

(51) Int. Cl. H02K 1/27; H02K 16/00; H02K 21/24

(52) U.S. Cl. CPC H02K 1/2793; H02K 21/24; H02K 16/00
USPC 310/156.36

(57) ABSTRACT

The Disc Alternator or Motor utilizes a magnetic field orientation that is parallel to the armature. With this orientation, multiple disc's are utilized to increase square area of induction and to provide a stronger field induction into the coils of a disc alternator or inversely a greater magnetic rotational force on magnetic or ferris armature disc's of a disc motor.

### BACKGROUND OF INVENTION

The Disc Alternator or Motor orientates the magnetic fields within the Disc Alternator or Motor parallel to the armature. This field orientation allows for the use of the multiple disc configuration of the Disc Alternator or Motor, greatly increasing the square area of induction and efficiency.

### SUMMERY OF INVENTION

By orienting the magnetic fields within the Disc Alternator or Motor parallel to the armature, the use of multiple Disc assemblies produces an increase in the field induction , resulting in greater output.

### DESCRIPTION OF DRAWINGS

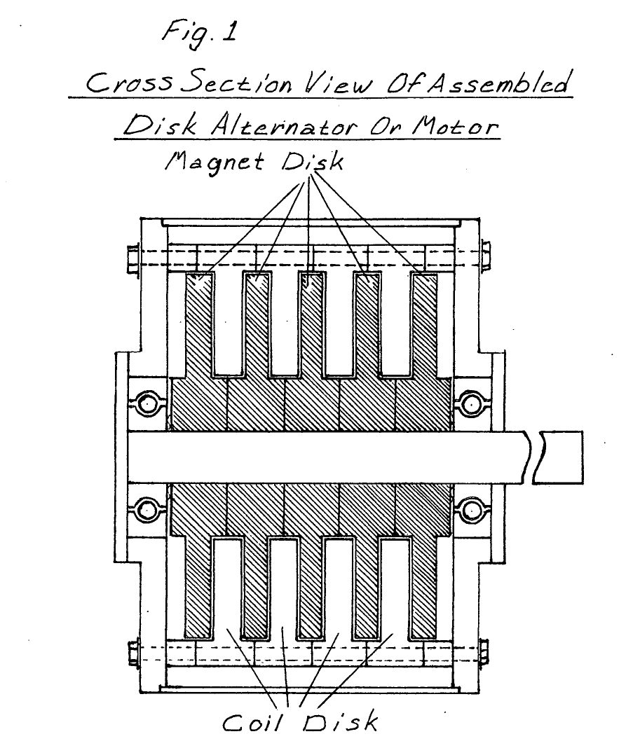

Sheet 1 FIG. 1 shows a cross section example of an assembled disc alternator or motor, to show the interlacing or fingered placement of stationary coil disc's and magnetic or ferris armature disc's.

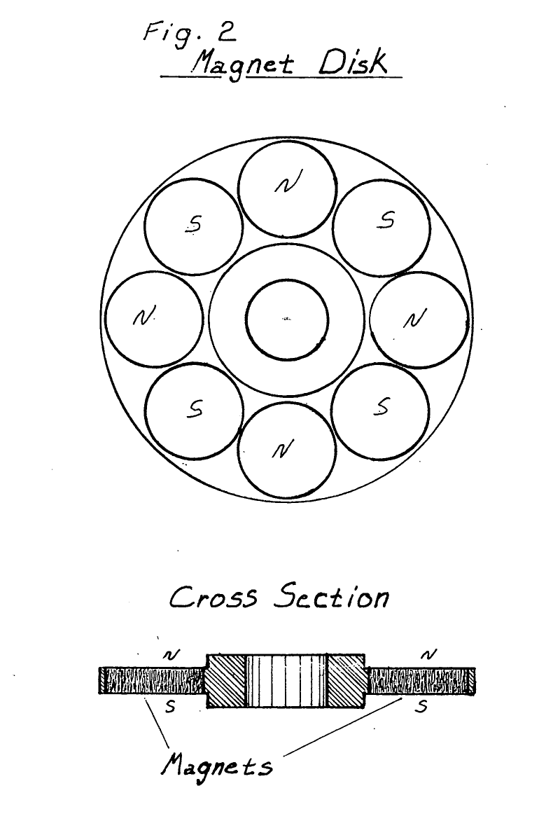

Sheet 2 FIG. 2 shows an example of a single magnet disc and with cross section view of same, shows magnetic polarity and over all magnet disc layout.

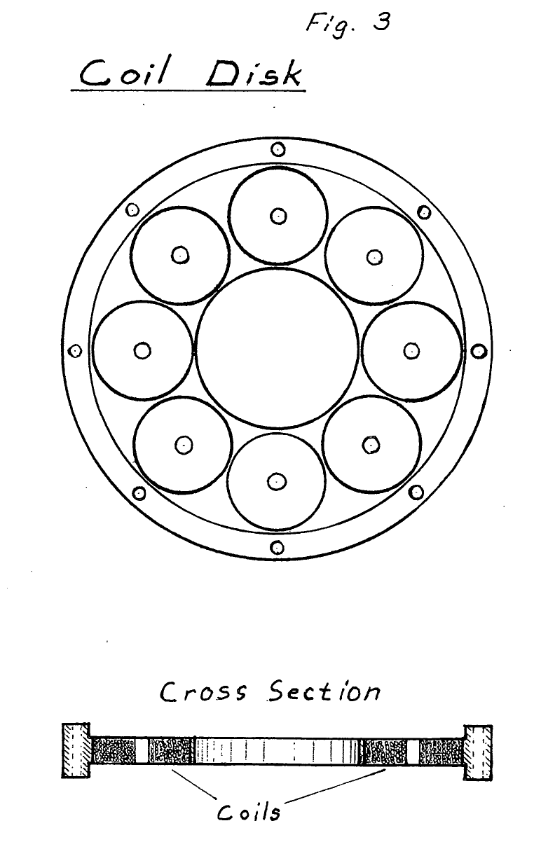

Sheet 3 FIG. 3 shows an example of a single coil disc and with cross section view of same, shows over all coil disc layout.

### DISC ALTERNATOR OR MOTOR

Reference, provisional application number 61/687,689

### Description of Invention

The disc alternator or motor is comprised of a series of magnetic armature discs for alternator application and magnetic or ferris core armature discs for motor application and stationary coil discs that are interlaced or fingered, as shown in FIG. 1 cross section view of assembled disc alternator or motor. This arrangement takes advantage of the surface area within the XY Axis of the interlaced discs. The large surface area of induction is also complimented by an efficient field transfer/induction into the coils by arranging the magnetic armature discs to place a North magnetic polarity on one side of a coil and a South magnetic polarity on the opposite side of the coil. The magnetic elements within each of the alternator armature discs are arranged so as to induce an alternating north south magnetic field into the coils of the coil discs as the armature rotates. The polarity arrangement of the magnetic discs are shown on FIG. 2 magnetic disc. With respect to the induction properties of the invention, applying an AC voltage to the coil discs and scewing one or more coil discs and or the magnetic or ferris armature discs to provide start phase, direction of rotation, its motor applications become viable. In some applications of the alternator form, the coil discs shown on FIG. 3 can be loaded with coils of different values to produce multiple voltages and currents. The coil discs can also be segmented into single coil segments for ease of change or replacement for some applications.

1. In the described configuration of an Alternator or Motor the square area of induction is increased.

2. The induction of the magnetic fields from both sides of a disc, provides for a greater field affect.
